(19) United States
(12) Patent Application Publication
(10) Pub. No.: US 2025/0310748 A1
(43) Pub. Date: Oct. 2, 2025

(54) TECHNIQUES FOR PROVIDING IMPROVED SERVICE SESSION INITIATION

(71) Applicant: T-Mobile USA, Inc., Bellevue, WA (US)

(72) Inventors: Khurram Ahmad Mirza, Bellevue, WA (US); Madhuri Kotta, Bellevue, WA (US)

(21) Appl. No.: 18/620,815

(22) Filed: Mar. 28, 2024

(51) Int. Cl. H04W 8/04; H04L 61/50; H04L 65/1016; H04L 101/654; H04W 28/24

(52) U.S. Cl. CPC H04W 8/04; H04L 61/50; H04L 65/1016; H04W 28/24; H04L 2101/654

(57) ABSTRACT

Techniques are described herein for providing improved IMS service routing. The techniques may be performed by a P-CSCF node operating within an IMS network. In embodiments, such techniques may comprise receiving an indication that the P-CSCF node has been assigned to a user equipment (UE), obtaining, from a Home Subscriber Server (HSS), information related to the UE, and storing the information related to the UE in the one or more non-transitory computer-readable media. The techniques may then comprise receiving a communication relating to a service to be provided to the UE, making a determination about the service to be provided to the UE based on the information related to the UE, and routing a message to an electronic device based on the determination about the service to be provided.

### BACKGROUND

Internet Protocol Multimedia Subsystem (IMS) is an architectural framework defined by the 3rd Generation Partnership Project (3GPP) for delivering Internet Protocol (IP) multimedia to user equipment (UE) of the IMS network. An IMS core network (sometimes referred to as the “IMS core”, the “Core Network (CN),” or the “IM CN Subsystem”) permits wireless and wireline devices to access IP multimedia, messaging, and voice applications and services. IMS allows for peer-to-peer communications, as well as client-to-server communications over an IP-based network.

During a registration procedure with the IMS core network, the UE is assigned a serving call session control function (S-CSCF) node and an application server (AS). These assigned nodes are tasked with serving the UE during a subsequent communication session, and all signaling originating from, and terminating at, the UE during the communication session is to be routed through the assigned nodes of the IMS core.

In a typical IMS network, a number of communications are routed between the various nodes in the IMS network in relation to IMS services requested by each UE. Each such communication may require interactions between a number of nodes in the network. When hundreds, or thousands, of UEs are requesting IMS services, this can result in a significant amount of bandwidth being dedicated to such communications, which can negatively impact the IMS network.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts a diagram illustrating an overview of an IMS network 100 having a number of nodes implemented in accordance with some embodiments;

FIG. 2 depicts a swim lane diagram illustrating an example process for provisioning information about a user equipment onto an assigned P-CSCF node in an IMS network in accordance with at least some embodiments;

FIG. 3 depicts a swim lane diagram illustrating a first example of a process for providing improved routing for IMS services in accordance with some embodiments;

FIG. 4 depicts a swim lane diagram illustrating a second example of a process for providing improved routing for IMS services in accordance with some embodiments;

FIG. 5 depicts a flow chart illustrating an exemplary process for providing improved IMS service routing using information locally stored on the P-CSCF node in accordance with at least some embodiments;

FIG. 6 shows an example computer architecture for an IMS node 600 capable of executing program components for implementing the functionality described above.

### DETAILED DESCRIPTION

This disclosure describes techniques and systems for providing improved service session initiation over an IMS network. In embodiments, such techniques may include provisioning information about a UE (and/or an account associated with the UE) onto a P-CSCF node that is assigned to the UE. Such information may be downloaded by the P-CSCF node into a local repository from the HSS upon registration of the UE on the IMS network.

During operation, such as when an IMS service is to be provided to a UE, the P-CSCF node can make a determination about whether, as well as how, such a service is to be provided to the UE without communicating with other IMS nodes. In some cases, the P-CSCF node is able to identify one or more attributes related to the requested service and may compare the information stored locally in relation to the UE against the one or more attributes to determine if the service should be provided. If the P-CSCF node determines that the service should not be provided, then rejection message (e.g., an error code) can be provided to the requesting entity while minimizing the number of communications over the IMS network.

Embodiments of the disclosure provide for a number of advantages over conventional systems. For example, the implemented system allows for information about user equipment (and/or a user account) is downloaded to a P-CSCF node when the user equipment is registered with an IMS network. In this example, when the P-CSCF node receives a communication related to that UE (e.g., either directed to or received from the UE), the P-CSCF node can make service-related decisions base on such information and absent any additional communications with other nodes in the IMS network. This reduces the impact that providing IMS services has on the IMS network while also allowing policy decisions to be made faster and using fewer resources.

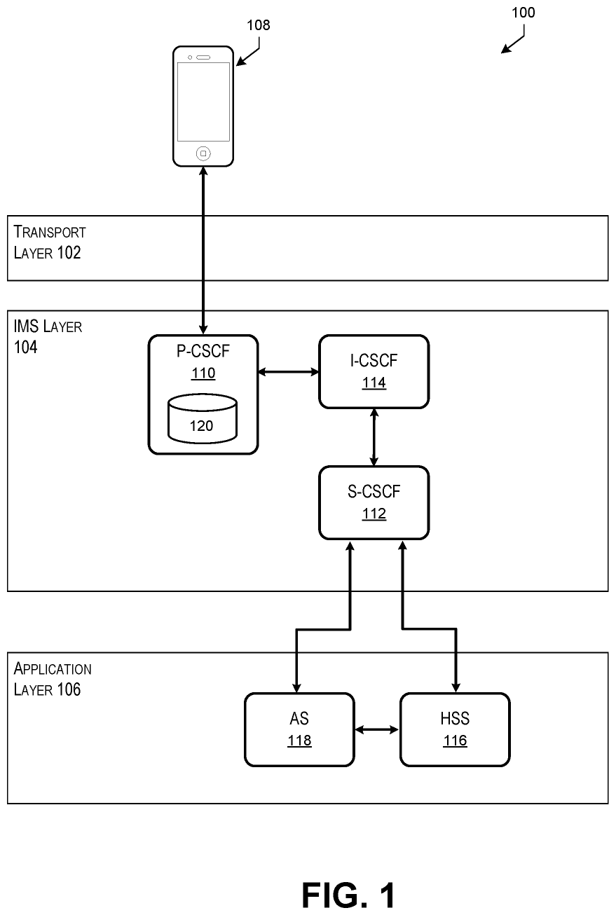

FIG. 1 depicts a diagram illustrating an overview of an IMS network 100 having a number of nodes implemented in accordance with some embodiments. In embodiments, the IMS network 100 may be made up of multiple layers, each of which includes a different set of nodes. For example, the IMS network may include at least a transport layer 102, an IMS layer 104, and an application layer 106.

A transport layer 102 may include any node (e.g., equipment) configured to provide access (e.g., ingress/egress) to the IMS network 100 for a number of user equipment (UE) 108. For example, a transport layer 102 may include a gateway device, such as a gateway that provides fixed access (e.g., digital subscriber line (DSL), cable modems, Ethernet, FTTx), mobile access (e.g., 5G NR, LTE, W-CDMA, CDMA2000, GSM, GPRS), and/or wireless access (e.g., WLAN, WiMAX).

An IMS layer 104 (also referred to as a control layer) may include any node configured to process SIP signaling packets within the IMS network 100. Such nodes may generally be referred to as Call Session Control Function (CSCF) nodes. CSCF nodes can be further distinguished based on their respective roles. For example, CSCF nodes may include a Proxy CSCF (P-CSCF), a Service CSCF (S-CSCF), and an Interrogating CSCF (I-CSCF). It is to be appreciated that the IMS network can include additional nodes that are not described herein such as nodes including, without limitation, an emergency CSCF (E-CSCF) node, a security gateway (SEG), a session border controller (SBC), and so on.

A P-CSCF node is a proxy device that acts as a first point of contact for UE 108 within the IMS Network. Each UE is assigned to a respective P-CSCF when it is registered with the IMS Network. A P-CSCF node can receive, via a communications interface, a Session Initiation Protocol (SIP) request from the UE 108 to be forwarded to a S-CSCF.

In embodiments, the P-CSCF node 110 may maintain a data repository 120 related to the UE 108 and/or a user account associated with the UE 108. Upon receiving a SIP request from the UE 108, the P-CSCF node 110 may make a determination about a service requested in the SIP request based on the information stored in relation to the UE 108. Moreso, the P-CSCF node 110 may make such a determination without consulting with the HSS 116 upon receiving such a SIP request, ultimately reducing the number of communications between nodes in the IMS network.

A S-CSCF node is the central nodes of the signaling plane and sits on the path of all signaling messages to/from a UE 108 that is assigned to it. There can be multiple S-CSCFs in the network for load distribution and high availability reasons. A S-CSCF is typically assigned to a user (or UE) by a Home Subscriber Server (HSS), when it's queried by the I-CSCF.

A S-CSCF node 112 may represent an available S-CSCF node that is chosen (or otherwise selected) for assignment to the UE 108. S-CSCF nodes, such as the S-CSCF node 112, are sometimes referred to as “Registrars,” and the process of allocating Registrars among users who are registering for IMS-based services is sometimes referred to as finding a “home CSCF” for the UE 108.

A I-CSCF node 114 is a SIP function node that acts as a forwarding point for external devices. The I-CSCF node 114 queries the HSS to determine S-CSCF/UE mapping and forwards SIP requests between the P-CSCF node 110 and the respective S-CSCF node 112.

An application layer 106 (also referred to as a service layer) may include one or more nodes capable of providing IMS-related services to the UE 108. In embodiments, the application layer 106 may include at least a Home Subscriber Server (HSS) 116 as well as a number of Application Servers (AS) 118. Note, however, that while the HSS 116 is described as being included in an application layer, the HSS 116 may be included in an IMS layer 104 in some embodiments of an IMS network 100.

The HSS 116 is typically a master user database that supports the IMS network nodes that handle the calls/sessions. It contains user profiles, performs authentication and authorization of the user, and can provide information about the physical location of a user. A user profile may be associated with each UE 108 and may contain information about the current user. Such information may be downloaded by the P-CSCF assigned to the user when the user is registered on the network. The P-CSCF may receive at least a portion of that information in a User-data Attribute Value Pair (AVP) format.

An AS 118 hosts and executes services, and interface with the S-CSCF using SIP. Depending on the actual service, the AS can operate in SIP proxy mode, SIP UA (user agent) mode or SIP B2BUA mode. An AS can be located in the IMS network 100 or in an external third-party network. If located in the IMS network 100, it may be able to query, or otherwise interact with the HSS 116 (e.g., using Diameter interfaces). In embodiments, the AS manages an application that provides communication between two or more UEs (e.g., UE 108 and at least one other UE). For example, the AS may manage an application that provides Voice over IP (VOIP) communications between UE devices.

The UE 108 may include any electronic device capable of interacting with the IMS network 100. In some non-limiting examples, the UE 108 may be a variety of devices including, for example: a mobile phone, a personal data assistant (PDA), or a mobile computer (e.g., a laptop, notebook, notepad, tablet, etc.) having mobile wireless data communication capability. The UE 108 may be configured to register for, and thereafter access and utilize, one or more IMS-based services via the IMS network 100. To this end, the UE 108 may be configured to transmit, via a radio access network (RAN), messages to the IMS network. For example, the UE 108 may transmit messages to the IMS network as part of an IMS registration procedure where the UE 108 is requesting to register for an IMS-based service.

In operation, the UE 108 may, upon registration with the IMS network 100, initially be assigned to a P-CSCF node 110 as well as a S-CSCF node 112. At the time of this assignment, the P-CSCF node 110 can download information related to the UE 108 to be stored at in a data repository 120.

During operation, when the P-CSCF node 110 receives a SIP request in relation to the UE 108, that P-CSCF node 110 may make decisions (e.g., routing decisions) about the SIP request based on the information about the UE 108.

In a first example, the P-CSCF node 110 may receive a SIP request from the UE 108 that relates to the use of an IMS service provided by an AS 118. In this example, upon receiving the SIP request, the P-CSCF node 110 may make a determination, based on the information about the UE 108 stored in the data repository 120, as to whether the requested IMS service is available/accessible to the UE 108. In some cases, this may involve making a determination as to whether the service is capable of being supported by the UE 108 based on a type or model of the UE 108. In other cases, this may involve making a determination as to whether a service level agreement (SLA) for the UE 108 permits such an IMS service for the UE 108.

In a second example, the P-CSCF node 110 may receive a SIP request from the AS 118 that is directed to the UE 108. In such an example, the P-CSCF node 110 may make a determination as to whether the SIP request should be forwarded to the UE 108. Like the example above, the P-CSCF node 110 may make a determination, based on the information about the UE 108 stored in the data repository 120, as to whether the requested IMS service is available/accessible to the UE 108.

In accordance with various embodiments described herein, the terms “user equipment (UE),” “wireless communication device,” “wireless device,” “communication device,” “mobile device,” and “client device,” may be used interchangeably herein to describe any UE (e.g., the UE 108) that is capable of transmitting/receiving data over the IMS network, perhaps in combination with other networks. A users can utilize the UE 108 to communicate with other users and associated UEs via the IMS network. For example, a service provider may offer multimedia telephony services that allow a subscribed user to call or message other users via the IMS network using his/her UE 108. A user can also utilize the UE 108 to receive, provide, or otherwise interact with various different IMS-based services by accessing the IMS network. In this manner, an operator of the IMS network may offer any type of IMS-based service, such as, telephony services, emergency services (e.g., E911), gaming services, instant messaging services, presence services, video conferencing services, social networking and sharing services, location-based services, push-to-talk services, and so on.

Furthermore, the IMS network that includes the IMS nodes 110-114 may enable peer-to-peer, client-to-client, and/or client-to-server, communications over wired and/or wireless networks using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VOIP), Voice over LTE (VOLTE), IEEE 802.1x protocols, WiMAX, Wi-Fi, Data Over Cable Service Interface Specification (DOCSIS), digital subscriber line (DSL), and/or any future IP-based network technology or evolution of an existing IP-based network technology.

The IMS network 100 of FIG. 1 may be maintained and/or operated by one or more service providers, such as one or more wireless carriers (“operators”), that provide mobile IMS-based services to users (sometimes called “subscribers”) who are associated with UEs, such as the UE 108. The IMS network may represent any type of SIP-based network that is configured to handle/process SIP signaling packets or messages. SIP is a signaling protocol that can be used to establish, modify, and terminate multimedia sessions (e.g., a multimedia telephony call) over packet networks, and to authenticate access to IMS-based services. Individual nodes of the IMS nodes 110-114 of FIG. 1 can also be configured to transmit data to/from the HSS 116 using Diameter protocol over a Diameter (Cx) interface. Diameter protocol is defined by the Internet Engineering Task Force (IETF) in RFC 6733.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

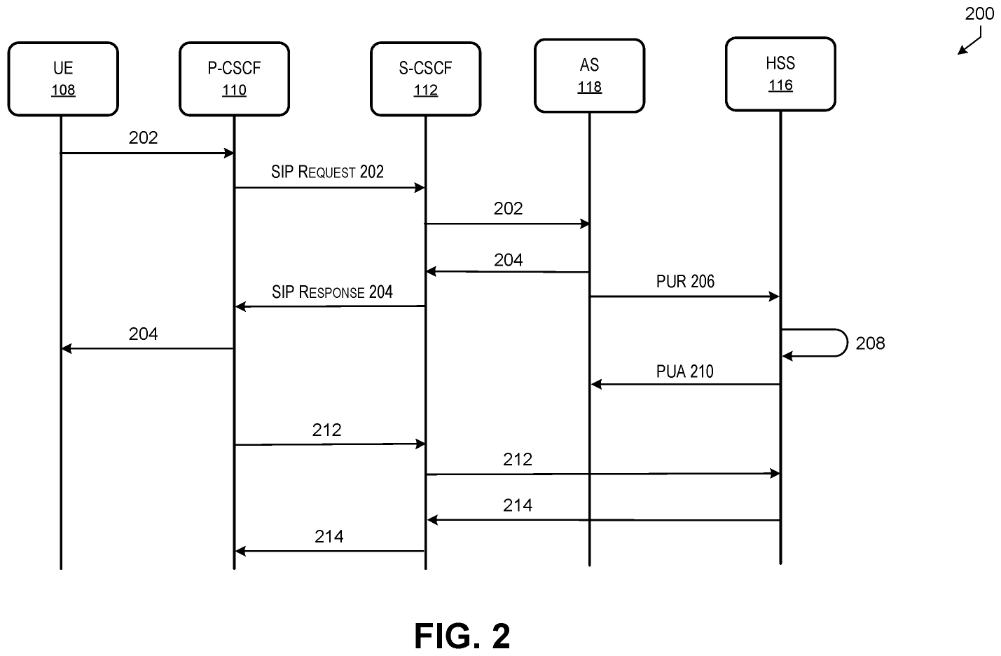

FIG. 2 depicts a swim lane diagram illustrating an example process for provisioning information about a user equipment onto an assigned P-CSCF node in an IMS network in accordance with at least some embodiments. More particularly, the process 200 illustrates example signaling between a UE (e.g., UE 108) and various IMS nodes within the IMS network to create a repository of UE related information locally on a P-CSCF node to be subsequently used in providing IMS services.

The IMS network can include various IMS nodes, including the IMS nodes shown in FIG. 1. Notably, such IMS nodes may include a P-CSCF node 110, a S-CSCF node 112, a AS 118, and a HSS 116. It is to be appreciated that the IMS network can include additional nodes that are not shown in FIG. 2, such as nodes including, without limitation, an interrogating CSCF (I-CSCF) node, an emergency CSCF (E-CSCF) node, a security gateway (SEG), a session border controller (SBC), and so on.

In the process 200, a UE 108 may be configured to register for, and thereafter access and utilize, one or more IMS-based services via the IMS network. To this end, the UE 108 may be configured to transmit, via a radio access network (RAN), messages to the IMS nodes on the IMS network. For example, the UE 108 may transmit messages to the IMS network as part of an IMS registration procedure where the UE 108 is requesting to register for an IMS-based service.

Accordingly, a registration procedure for the UE 108 can involve identifying the P-CSCF node 110 and sending a registration request via the RAN to the P-CSCF node 110. SIP may be used for transmitting such a registration message. As used herein, a “SIP request” is a message that is sent using SIP protocol. Accordingly, a SIP request 202 that uses the SIP “REGISTER” method may be sent to the P-CSCF node 110 during an IMS registration procedure in order to request registration of the UE 108 for an IMS-based service.

The P-CSCF node 110 receives the SIP request 202 (e.g., using the SIP REGISTER method) from the UE 108, and forwards the SIP request 202 to the S-CSCF node 112. It is to be appreciated that intermediate nodes can exist between any two adjacent IMS nodes shown in FIG. 2. For example, an I-CSCF node can be interposed between the P-CSCF node 110 and the S-CSCF node 112 to process the SIP request 202 and forward the SIP request 202 to the S-CSCF node 112. It is also to be appreciated that a user of the UE 108, and/or the UE 108 itself, can be authenticated, such as by using credential validation, signature verification, and the like, as part of the registration procedure.

The S-CSCF node 112 receives the SIP request 202 from the P-CSCF node 110 (or from an intermediate IMS node), and forwards the SIP request 202 to the AS 118. The AS 118 can be configured to provide any of the IMS-based services described herein as part of a subsequently established communication session. The AS 118 can be selected in any suitable fashion. For example, the S-CSCF node 112 can issue a third-party register (TPR) message to discover the AS 118 as an available AS for serving the UE 108. Various additional checks and authentication procedures can be performed during the registration process 200. If the results of the checks and authentication procedures indicate that the UE 108 can be registered on the IMS network, the AS 118 can send a SIP response message 204 (e.g., in the form of a 200 OK message) to confirm the successful registration of the UE 108. The SIP response message 204 can be received by the S-CSCF node 112, and the S-CSCF node 112 can forward the SIP response message 204 to the P-CSCF node 110, which is ultimately received at the UE 108. Before the SIP response message 204 is forwarded by each IMS node, an individual IMS node (e.g., the AS 118, the S-CSCF node 112, etc.) may insert its identifier within a message header of the SIP response message 204 to tell another IMS node that the UE 108 is assigned to the IMS nodes identified in the message header. In this manner, future SIP requests originating from the UE 108 can be forwarded to the appropriate IMS node (e.g., the P-CSCF node 110 knows to forward a SIP request originating from the UE 108 to the S-CSCF node 112).

The AS 118 may be further configured to send information about the registration of the UE 108 to an IMS service to the HSS 116 for storage at the HSS 116 as part of the registration procedure for the UE 108. Such information can be transmitted from the AS 118 to the HSS 116 over a Diameter interface in the form of a profile update request (PUR) message 206. Uploading the information in this manner is sometimes referred to herein as “updating” the Attribute Value Pairs (AVPs). For example, the AS 118 can send a first value for the active AS name attribute to update the “active AS name” AVP. The AS 118 can also send a second value for the user registration data attribute to update the “user registration data” AVP. It is to be appreciated that additional AVPs to those described here can also be transmitted to the HSS 116 over the Diameter interface in the PUR message 206. For example, a “S-CSCF name” AVP can also be included in the PUR message 206, which identifies the S-CSCF node 112 that was assigned to the UE 108.

The HSS 116 can be associated with a master database (sometimes referred to herein as an “HSS repository”) that maintains data pertaining to multiple UE (including UE 108) that have registered, or are in the process of registering, on the IMS network. Accordingly, the HSS 116 can receive information about a number of AVPs from the AS 118 over the Diameter interface, and can store the AVPs in association with the UE 108 in the master database at 208.

The AS 118 can receive a profile update answer (PUA) message 210 from the HSS 116 in response to the PUR message 206. The PUA message 210 can confirm that the AVPs were successfully updated in the HSS repository. The PUA message 210 can be sent over a Diameter interface from the HSS 116 to the AS 118.

In some embodiments, the AS 118 can send a subscription notification request (SNR) message that is issued as a request to receive any future notification of a change in the IMS user state for the UE 108. For example, if the UE 108 is reassigned to an alternative node (e.g., as a result of a restoration process), the HSS 116 can send a subscription notification answer (SNA) message to the AS 118 so that the AS 118 is made aware of such a reassignment and can clear any local contact binding for the reassigned UE 108.

At some time that is subsequent to the performance of the registration process for the UE 108, the P-CSCF node 110 may provide a SIP request to the HSS 116 for information about the UE 108 at 212. It should be noted that the P-CSCF node 110 may typically not be in direct communication with the HSS 116 in a typical IMS network. Accordingly, the SIP request sent by the P-CSCF node 110 to the HSS 116 may be routed through the S-CSCF node 112.

Upon receiving a SIP request for UE information, the HSS 116 may provide the P-CSCF node 110 with access to various information stored in the master database in relation to an account associated with the UE 108. For example, such information may include information about a type or model of the UE 108. In another example, such information may include information about a service level agreement associated with the UE 108 indicating which, if any, services should be provided to the UE 108. In yet another example, the information may include an indication of one or more identifiers for the UE 108, such as an International Mobile Equipment Identifier (IMEI) or a serial number.

Upon being provided access to the UE information as hosted by the HSS 116, the P-CSCF node 110 may download at least a portion of that information as depicted at 214. Once more, because the P-CSCF node 110 does not typically have direct access to the HSS 116, such a download of information may be routed through the S-CSCF node 112 that is assigned to the P-CSCF node 110 during the registration process.

Once the UE 108 is successfully registered on the IMS network, the UE 108 can originate a communication session, such a voice communication session (e.g., a phone call). Unless and until the S-CSCF node 112 and/or the AS 118 become unavailable, all SIP signaling that is part of the communication session, and that originates and terminates at the UE 108, is routed through the assigned S-CSCF node 112 and the AS 118.

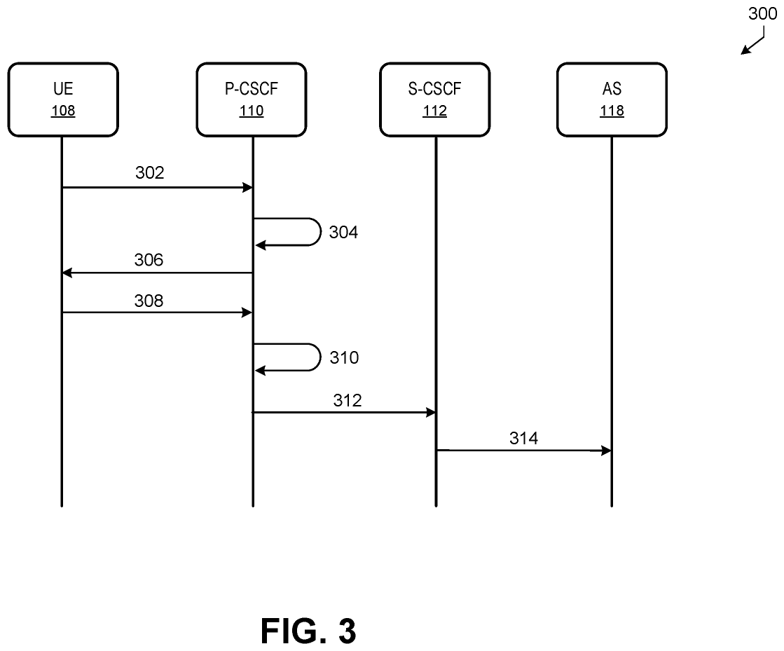

FIG. 3 depicts a swim lane diagram illustrating a first example of a process for providing improved routing for IMS services in accordance with some embodiments. The process 300 is depicted as a number of interactions between a UE 108 and various nodes of the IMS network, and more particularly, a P-CSCF node 110, a S-CSCF node 112, and a AS 118. More particularly, this first example illustrates a process for providing improved IMS service routing for a UE that initiates a communication session (e.g., the UE is an originating UE).

At 302, the P-CSCF node 110 may receive a first SIP request from the UE 108 as part of a communication session established for the UE 108. For example, the SIP request can comprise a SIP message that uses the SIP INVITE method to establish the communication session. As such, the P-CSCF node 110 can receive a SIP request that uses the SIP INVITE method to originate a communication session (e.g., a voice communication session with another UE).

Upon receiving the SIP message, the P-CSCF node may make a determination about an IMS service indicated in that SIP message at 304. Such a determination may be made based at least partially upon information stored locally by the P-CSCF node about the UE and/or an account associated with that UE.

In some embodiments, a determination about an IMS service may relate to whether the service can/should be provided to a user. Such a determination may involve deciding whether the UE is capable of supporting the service, such as whether the UE has the necessary hardware and/or software capable of executing the service. For example, if the IMS service requires a particular hardware component or software application, the P-CSCF node may be able to quickly determine whether the UE has it and subsequently whether the IMS service should be provided to the UE. By way of illustration, an IMS service that requires a particular CODEC will not be provided to a UE that does not have the ability to support its format.

In some cases, determinations about capabilities of a UE may be made based on an identifier for the UE. For example, an International Mobile Subscriber Identity (IMSI) of the UE (or alternatively an IMEI) may be used to determine a type or category of that UE. In such an example, a type of device for the UE can be determined based on the first 6 digits of the IMSI and the P-CSCF node may then determine whether the IMS service is available to that type of device. By way of illustration, a request for an IMS service that is provided to a particular type of Internet of Things (IoT) device may be rejected if the IMSI of the requesting device indicates that it is not that type of IoT device.

In some embodiments, a determination about an IMS service may relate to whether the service can be provided in a region/area associated with the UE. For example, the P-CSCF node may store information relating to a Mobile Country Code (MCC) and/or a Mobile Network Code (MNC) that identifies a country and network associated with the user. Note that the combination of MCC and MNC may sometimes be referred to as a Home Network Identifier (HNI). In this example, the requested IMS service may not be available in certain regions or on certain networks. In these embodiments, the request can be rejected before being sent on to the AS 118, resulting in quick request resolution.

In some embodiments, the determination about the IMS service may relate to whether, or how, a session restoration procedure should be performed in the event of a node (e.g., a S-CSCF node) failure. For example, the information about a service level agreement (SLA) for the user can be used when assigning a replacement S-CSCF node. Alternatively, information the SLA may be used to determine that the communication should fail open if there is a core outage.

In some cases, a determination may be made as to whether a quality of service (QOS) associated with the UE is being met. For example, an operator of the UE may subscribe to a particular level of service as outlined in an SLA. In this example, metrics obtained in relation to the IMS services provided to the UE over time may be stored and compared to information included in the SLA for the UE to determine whether QOS expectations are being met. In some cases, the P-CSCF node 110 may, upon making a determination that the QOS expectations are not being met, update configuration/routing settings associated with the UE in order to improve the IMS services being provided.

For the first SIP request, the P-CSCF node 110 may make a determination that the IMS service should not be provided to the UE 108 based on the information that it has stored in its local repository. In such a case, the P-CSCF node 110 may provide a response to the SIP message at 306 in which the IMS service is declined. In some cases, such a response may include an error message or another negative indication. In some cases, upon receiving the response at 306, the UE 108 may end its current communication session. Note that the determination as to whether the IMS service should be provided is made absent any additional communication between the various nodes of the IMS network. This results in little to no bandwidth usage in relation to determinations about providing IMS services at the P-CSCF node 110, improving the responsiveness and efficiency of the IMS network as a whole.

At 308, the P-CSCF node 110 may receive a second SIP request from the UE 108 as part of the communication session established for the UE 108, which may also include a SIP request that uses the SIP INVITE method.

Once more, the P-CSCF node 110 may make a determination at 310 about whether the IMS service should be provided to the UE 108 based on the information that it has stored in its local repository. For the second SIP request, the P-CSCF node 110 may make a determination that the IMS service should be provided to the UE 108. Upon making such a decision, the P-CSCF node 110 may relay the SIP message to the S-CSCF node 112 at 312. Upon receiving the SIP message, the S-CSCF node 112 may forward the SIP message to a AS 118 that is associated with the requested IMS service at 314.

Once the communication has been provided to the AS 118, the AS 118 can then forward the SIP request to a next hop (i.e., a next IMS node). In the case of a communication session with another UE, the SIP request can ultimately be forwarded as a SIP response to the other UE in order to allow the multiple UEs to communicate over the IMS core.

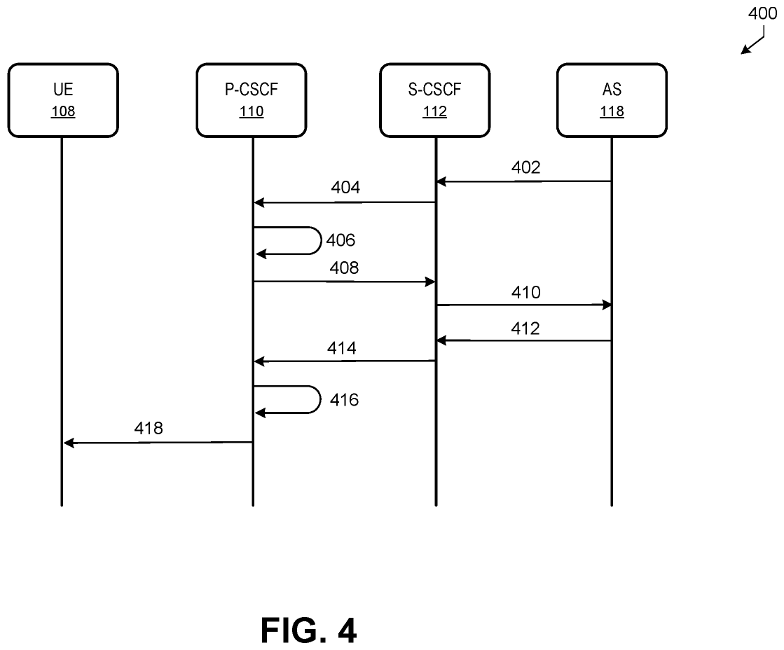

FIG. 4 depicts a swim lane diagram illustrating a second example of a process for providing improved routing for IMS services in accordance with some embodiments. Like the process 300 of FIG. 3, the process 400 is depicted as a number of interactions between a UE 108 and various nodes of the IMS network, and more particularly, a P-CSCF node 110, a S-CSCF node 112, and a AS 118. More particularly, this second example illustrates a process for providing improved IMS service routing for a UE that is the target of a communication session (e.g., the UE is a terminating UE).

At 402, a AS 118 associated with an IMS service may determine that a communication related to that IMS service should be provided to the UE 108. For example, the AS 118 may provide UE to UE communication (e.g., VoIP communication) and may determine that a communication session is to be established between an originating UE and the UE 108.

In such a case, the AS 118 may identify the S-CSCF node 112 as being assigned to the UE 108. In such a case, the AS 118 may provide a first SIP request to the S-CSCF node 112 at 402. The S-CSCF node 112 may then forward the SIP request to the P-CSCF node 110 at 404.

Once the P-CSCF node 110 receives a first SIP request from the AS 118 in relation to an IMS service to be provided, it may make a determination as to whether to forward that SIP request to the UE 108 at 406. This determination by the P-CSCF node may be similar in nature to the determination described above in relation to 304 of FIG. 3.

For the first SIP request, the P-CSCF node 110 may make a determination that the IMS service should not be provided to the UE 108 based on the information that it has stored in its local repository. In such a case, the P-CSCF node 110 may provide a response to the AS 118 in which the IMS service is declined. In some cases, such a response may include an error message or another negative indication. In such cases, the P-CSCF node 110 provides the rejection SIP response back to the S-CSCF node 112 at 408 which then forwards the SIP response back to the AS 118 at 410.

At a different time, the AS 118 may determine that a second communication related to that IMS service should be provided to the UE 108. In such a case, the AS 118 may once more identify the S-CSCF node 112 as being assigned to the UE 108. The AS 118 may then provide a second SIP request to the S-CSCF node 112 at 412. The S-CSCF node 112 then forwards the second SIP request to the P-CSCF node 110 at 414.

Once more, the P-CSCF node 110 may make a determination at 416 about whether the IMS service should be provided to the UE 108 based on the information that it has stored in its local repository. For the second SIP request, the P-CSCF node 110 may make a determination that the IMS service should be provided to the UE 108. Upon making such a decision, the P-CSCF node 110 may relay the SIP message to the UE 108 at 418. Upon receiving the SIP message, the UE 108 may establish a communication session with the AS 118 over the respective nodes in the IMS network.

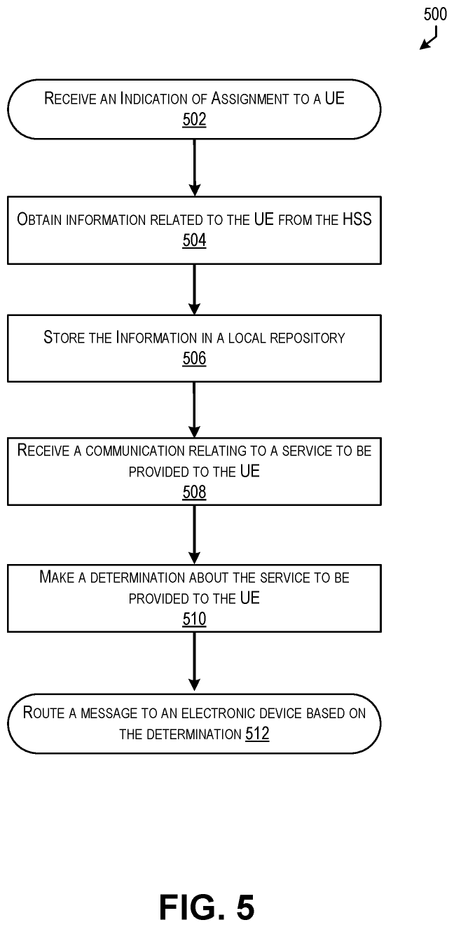

FIG. 5 depicts a flow chart illustrating an exemplary process for providing improved IMS service routing using information locally stored on the P-CSCF node in accordance with at least some embodiments. In embodiments, the process 500 may be performed within an IMS network (e.g., by a P-CSCF node) in order to provide IMS services. The HSS may maintain user profile data that stores information about individual accounts associated with the IMS network.

At 502, the process 500 may involve receiving, at a P-CSCF node, an indication of an assignment of that P-CSCF node to a particular UE. In some embodiments, the indication that the P-CSCF node has been assigned to the UE is received when the UE is registered with an IMS network that includes the P-CSCF node.

At 504, the process 500 may involve obtaining information related to the UE from the HSS. In some embodiments, the information related to the UE is provided by the HSS to the P-CSCF node via an assigned service call session control function (S-CSCF) node. At 506, the process 500 may involve storing the obtained information in a local repository of the P-CSCF node.

At 508, the process 500 may involve, at a subsequent time, receiving a communication relating to an IMS service to be provided to the UE. Such a communication may be a Session Initiation Protocol (SIP) request. In some embodiments, the communication relating to the service to be provided to the UE is received from an application server and is directed to the UE (e.g., the UE is a terminating device). In some embodiments, the communication relating to the service to be provided to the UE is received from the UE and is directed to an application server (e.g., the UE is an originating device).

At 510, the process 500 may involve making a determination about the service related to the IMS service. the determination about the service to be provided to the UE may be made without any additional communication between the HSS and the P-CSCF node.

In some embodiments, the determination about the service to be provided to the UE is made based on one or more capabilities determined to be associated with the UE. For example, the information related to the UE may include at least a unique identifier for the UE, and the one or more capabilities may be determined to be associated with the UE based on the unique identifier. In this example, the unique identifier may be one of an International Mobile Subscriber Identity (IMSI) or an International Mobile Equipment Identifier (IMEI).

In some embodiments, the determination about the service to be provided to the UE is made based on a service level agreement (SLA) associated with an account for the UE. For example, the determination about the service to be provided to the UE may be made based on metrics obtained in relation to the service to be provided to the UE and quality of service (QOS) requirements indicated in the SLA. In this example, the QOS requirements may include an indication of one or more thresholds associated with the metrics obtained in relation to the service, such that a determination may be made as to whether one or more values associated with the metrics exceeds or falls below a respective threshold value.

In some embodiments, the determination about the service to be provided to the UE is made based on an availability of the service in a geographic region with which the UE is associated. For example, the determination may be a determination as to whether or not to provide the service in a region that the UE is currently located. In another example, certain services may not be available to residents of a particular region or area. In such cases, the determination may be a determination as to whether or not to provide a service to the UE based on a residency address associated with an account for the UE.

At 512, the process 500 may involve routing a message to an electronic device based on the determination. In some cases, the determination may be a determination to block the service the message is a rejection and the electronic device comprises a device from which the communication was received. In other cases, the determination is a determination to provide the service and routing the message to the electronic device is sending the communication to a next hop (e.g., the next device in a communication path) associated with the service.

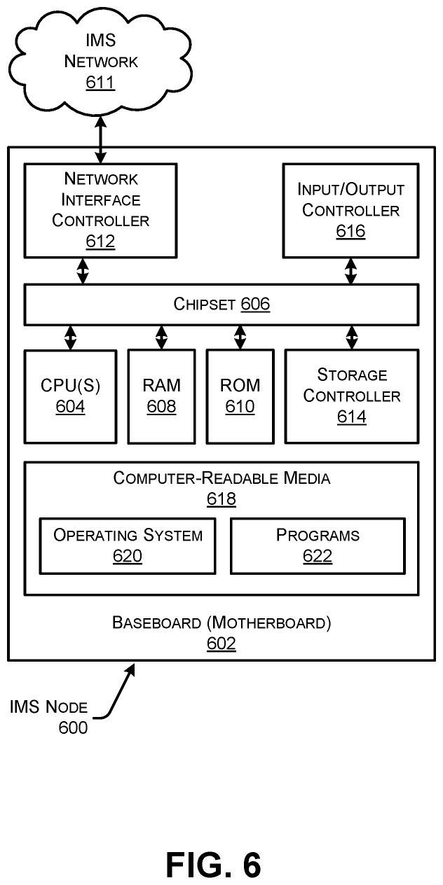

FIG. 6 shows an example computer architecture for an IMS node 600 capable of executing program components for implementing the functionality described above. The computer architecture shown in FIG. 6 illustrates a conventional server computer, workstation, desktop computer, laptop, tablet, network appliance, e-reader, smartphone, or other computing device, and can be utilized to execute any of the software components presented herein. The IMS node 600 may, in some examples, correspond to a physical server as described herein, and may comprise networked devices such as servers, switches, routers, hubs, bridges, gateways, modems, repeaters, access points, etc.

The IMS node 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the IMS node 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the IMS node 600. The chipset 606 can further provide an interface to a computer-readable storage medium such as a read-only memory (“ROM”) 610 or non-volatile RAM (“NVRAM”) for storing basic routines that help to startup the IMS node 600 and to transfer information between the various components and devices. The ROM 610 or NVRAM can also store other software components necessary for the operation of the IMS node 600 in accordance with the configurations described herein.

The IMS node 600 can operate in a networked environment using logical connections to remote computing devices and computer systems through a network, such as the network 611 (which may be an IMS network). The chipset 606 can include functionality for providing network connectivity through a NIC 612, such as a gigabit Ethernet adapter. The NIC 612 is capable of connecting the IMS node 600 to other computing devices over the network 611. It should be appreciated that multiple NICs 612 can be present in the IMS node 600, connecting the computer to other types of networks and remote computer systems.

The IMS node 600 can be connected to a storage device 618 that provides non-volatile storage for the computer. The storage device 618 can store an operating system 620, programs 622, and data, which have been described in greater detail herein. The storage device 618 can be connected to the IMS node 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The IMS node 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the IMS node 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The IMS node 600 can further read information from the storage device 618 by detecting the physical states or characteristics of one or more particular locations within the physical storage units.

In addition to the mass storage device 618 described above, the IMS node 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the IMS node 600. In some examples, the operations performed by devices as described herein may be supported by one or more devices similar to IMS node 600. Stated otherwise, some or all of the operations performed by an edge device, and/or any components included therein, may be performed by one or more IMS node 600 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the IMS node 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the IMS node 600.

In one embodiment, the storage device 618 or other computer-readable storage media is encoded with computer-executable instructions which, when loaded into the IMS node 600, transform the computer from a general-purpose computing system into a special-purpose computer capable of implementing the embodiments described herein. These computer-executable instructions transform the IMS node 600 by specifying how the CPUs 604 transition between states, as described above. According to one embodiment, the IMS node 600 has access to computer-readable storage media storing computer-executable instructions which, when executed by the IMS node 600, perform the various processes described above with regard to the other figures. The IMS node 600 can also include computer-readable storage media having instructions stored thereupon for performing any of the other computer-implemented operations described herein.

The IMS node 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the IMS node 600 might not include all of the components shown in FIG. 6, can include other components that are not explicitly shown in FIG. 6, or might utilize an architecture completely different than that shown in FIG. 6.

As described herein, the IMS node 600 may include one or more hardware processors (e.g., CPUs 604) (processors) configured to execute one or more stored instructions. The processor(s) may comprise one or more cores. Further, the IMS node 600 may include one or more network interfaces configured to provide communications between the IMS node 600 and other devices, such as the communications described herein as being performed by an edge device. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the network 611. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 622 may comprise any type of programs or processes to perform the techniques described in this disclosure. The programs 622 may comprise any type of program that cause the IMS node 600 to perform techniques for communicating with other devices using any type of protocol or standard usable for determining connectivity.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, IMS node 600 may also include computer executable instructions that, when executed by processor(s), utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, the IMS node 600 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at a proxy call session control function (P-CSCF) node, an indication that the P-CSCF node has been assigned to a user equipment (UE);
obtaining, by the P-CSCF node from a Home Subscriber Server (HSS), information related to the UE;
storing, by the P-CSCF node, the information related to the UE in a local repository;
receiving, by the P-CSCF node, a communication relating to a service to be provided to the UE;
making, by the P-CSCF node, a determination about the service to be provided to the UE based on the information related to the UE; and
routing, by the P-CSCF node, a message to an electronic device based on the determination about the service to be provided.

2. The method of claim 1, wherein the indication that the P-CSCF node has been assigned to the UE is received when the UE is registered with an IMS network.

3. The method of claim 1, wherein the determination about the service to be provided to the UE is made based on one or more capabilities determined to be associated with the UE.

4. The method of claim 3, wherein the information related to the UE comprises at least a unique identifier for the UE, and the one or more capabilities are determined to be associated with the UE based on the unique identifier.

5. The method of claim 4, wherein the unique identifier comprises one of an International Mobile Subscriber Identity (IMSI) or an International Mobile Equipment Identifier (IMEI).

6. The method of claim 1, wherein the determination about the service to be provided to the UE is made based on a service level agreement (SLA) associated with an account for the UE.

7. The method of claim 6, wherein the determination about the service to be provided to the UE is made based on metrics obtained in relation to the service to be provided to the UE and quality of service (QOS) requirements indicated in the SLA.

8. The method of claim 7, wherein the QOS requirements include an indication of one or more thresholds associated with the metrics obtained in relation to the service.

9. The method of claim 1, wherein the information related to the UE is provided by the HSS to the P-CSCF node via an assigned service call session control function (S-CSCF) node.

10. A proxy call session control function (P-CSCF) node comprising:
one or more processors; and
one or more non-transitory computer-readable media storing computer-executable instructions that, when executed by the one or more processors, cause P-CSCF node to perform operations comprising:
receiving an indication that the P-CSCF node has been assigned to a user equipment (UE);
obtaining, from a Home Subscriber Server (HSS), information related to the UE;
storing the information related to the UE in the one or more non-transitory computer-readable media;
receiving a communication relating to a service to be provided to the UE;
making a determination about the service to be provided to the UE based on the information related to the UE; and
routing a message to an electronic device based on the determination about the service to be provided.

11. The P-CSCF node of claim 10, wherein the communication relating to the service to be provided to the UE is received from an application server and is directed to the UE.

12. The P-CSCF node of claim 10, wherein the communication relating to the service to be provided to the UE is received from the UE and is directed to an application server.

13. The P-CSCF node of claim 10, wherein the determination comprises a determination to block the service the message comprises a rejection and the electronic device comprises a device from which the communication was received.

14. The P-CSCF node of claim 10, wherein the determination comprises a determination to provide the service and routing the message to the electronic device comprises sending the communication to a next hop associated with the service.

15. The P-CSCF node of claim 10, wherein the determination about the service to be provided to the UE is made based on an availability of the service in a geographic region with which the UE is associated.

16. A system comprising:
a home subscriber server (HSS); and
a proxy call session control function (P-CSCF) node configured to:
receive an indication that the P-CSCF node has been assigned to a user equipment (UE);
obtain, from the HSS, information related to the UE;
store the information related to the UE in a local repository;
receive a communication relating to a service to be provided to the UE;
make a determination about the service to be provided to the UE based on the information related to the UE; and
route a message to an electronic device based on the determination about the service to be provided.

17. The system of claim 16, wherein the determination about the service to be provided to the UE is made without any additional communication between the HSS and the P-CSCF node.

18. The system of claim 16, wherein the communication comprises a Session Initiation Protocol (SIP) request.

19. The system of claim 16, wherein the system further comprises a service call session control function (S-CSCF) node configured to relay the information related to the UE from the HSS to the P-CSCF node.

20. The system of claim 16, wherein the P-CSCF node is assigned to the UE when the UE is registered on a network in which the P-CSCF node is operating.
